(19) United States
(12) Patent Application Publication
(10) Pub. No.: US 2008/0139240 A1
(43) Pub. Date: Jun. 12, 2008

(54) Communication device capable of operating in a plurality of communications systems

(76) Inventors: Kun-Lang Lin, Taipei Hsien (TW); Yung-Jinn Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/874,932

(22) Filed: Oct. 19, 2007

(30) Foreign Application Priority Data
Dec. 7, 2006 (TW) 095145651

(51) Int. Cl. H04M 1/00

(52) U.S. Cl. 455/552.1

(57) ABSTRACT

A communication device capable of operating in a first and a second communications systems includes a radio signal transceiver module, a first reception module for receiving signals from the first communications system, a first transmitting module for transmitting signals to the first communications system, a second reception module for receiving signals from the second communications system, a second transmitting module for transmitting signals to the second communications system, a first filtering unit coupled to the first transmitting module for filtering out signals in an overlapping frequency band between the first transmitting module and the second reception module, and a second filtering unit coupled to the second transmitting module for filtering out signals in an overlapping frequency band between the second transmitting module and the first reception module.

### BACKGROUND OF THE INVENTION

1. Field of the Invention

The present invention relates to a communication device, and more particularly, to a communication device capable of operating in a plurality of communications systems.

2. Description of the Prior Art

As radio communications technology progresses, mobile phones of small sizes change the way people communicate. The mobile phones provide people an opportunity to exchange information any time anywhere. The prior art developed different mobile communications systems, such as Global System for Mobile communications (GSM), Code Division Multiple Access (CDMA), Wideband Code Division Multiple Access (WCDMA), Personal Digital Cellular (PDC), and Personal Handyphone System (PHS).

The GSM communications system is composed of the GSM communications systems with frequencies of 900 MHz and 1100 MHz. The CDMA communications system is composed of the cellular CDMA communications system of 800 MHz and the Personal Communications Services (PCS) CDMA communications system of 1900 MHz. The PHS is composed of PHSs with frequencies of 800 MHz and 1500 MHz.

Please refer to FIG. 1. FIG. 1 is a diagram illustrating the frequency distribution of the communications systems of the prior art. As shown in FIG. 1, the frequency bands of communications systems overlap each other, causing a communication device (such as a cellular phone) to be unable to operate simultaneously in two communications systems of different communications protocol. Besides, if a communication device, in the communications systems of the same communications protocol, executing the dual mode and the dual standby states, the transmission quality of the communication device is lowered because the frequency bands of the two communications systems overlap each other so that both of the two communications systems are interfered with each other.

### SUMMARY OF THE INVENTION

The present invention provides a communication device capable of operating in a first communications system and a second communications system. The communication device comprises a radio signal transceiver module for receiving and transmitting radio signals; a first reception module for receiving radio signals from the first communications system through the radio signal transceiver module; a first transmitting module for transmitting radio signals to the first communications system through the radio signal transceiver module; a second reception module for receiving radio signals from the second communications system through the radio signal transceiver module; a second transmitting module for transmitting radio signals to the second communications system through the radio signal transceiver module; a first filtering unit coupled to the first transmitting module for filtering out signals of an overlapping frequency band between a frequency band of output signals of the first transmitting module and a frequency band of received signals of the second reception module; and a second filtering unit coupled to the second transmitting module for filtering out signals of an overlapping frequency band between a frequency band of output signals of the second transmitting module and a frequency band of received signals of the first reception module.

The present invention further provides a communication device capable of operating in a first communications system and a second communications system. The communication device comprises a radio signal transceiver module for receiving and transmitting radio signals; a first reception module for receiving radio signals through the radio signal transceiver module from the first communications system; a first transmitting module for transmitting radio signals through the radio signal transceiver module to the first communications system; a second reception module for receiving radio signals through the radio signal transceiver module from the second communications system; a second transmitting module for transmitting radio signals through the radio signal transceiver module to the second communications system; a first filtering unit coupled to the first transmitting module for filtering out signals of an overlapping frequency band between a frequency band of output signals of the first transmitting module and a frequency band of received signals of the second reception module; and a third filtering unit coupled to the first reception module for filtering signals received by the first reception module so as to increase a degree of an isolation and avoid signal saturation of front end components.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the frequency distribution of the communications systems of the prior art.

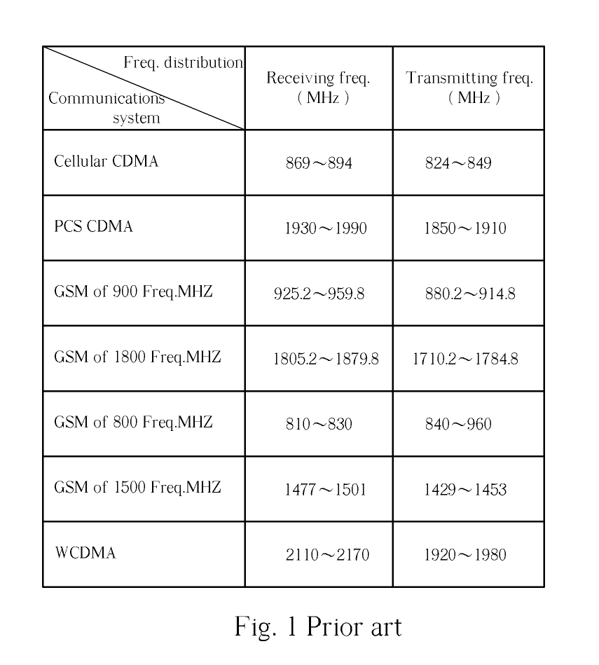

FIG. 2 is a diagram illustrating a communication device of a first embodiment of the present invention.

FIG. 3 is diagrams illustrating a radio signal transceiver module utilized in FIG. 2.

FIG. 4 is diagrams illustrating another radio signal transceiver module utilized in FIG. 2.

FIG. 5 is a diagram illustrating the reception path of the communication device provided with the third filtering unit and the fourth filtering unit.

FIG. 6 is a diagram illustrating a communication device of a second embodiment of the present invention.

FIG. 7 is a diagram illustrating a communication device of a third embodiment of the present invention.

FIG. 8 is diagrams illustrating a radio signal transceiver module utilized in FIG. 7.

FIG. 9 is diagrams illustrating another radio signal transceiver module utilized in FIG. 7.

### DETAILED DESCRIPTION

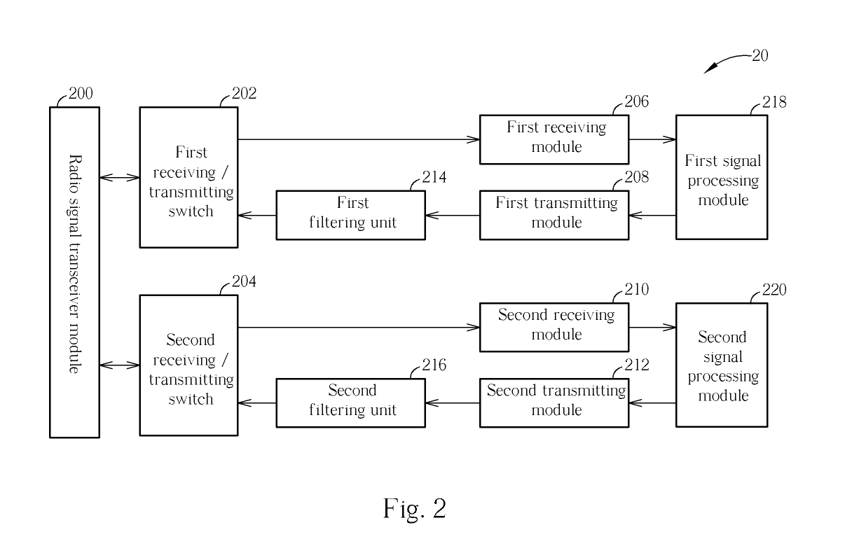

Please refer to FIG. 2. FIG. 2 is a diagram illustrating a communication device 20 of a first embodiment of the present invention. The communication device 20 operates simultaneously in a first communications system and a second communications system. The communication device 20 comprises a radio signal transceiver module 200, a first receiving/transmitting switch 202, a second receiving/transmitting switch 204, a first reception module 206, a first transmitting module 208, a second reception module 210, a second transmitting module 212, a first filtering unit 214, a second filtering unit 216, a first signal processing module 218, and a second signal processing module 220.

The radio signal transceiver module 200 is disposed for receiving and transmitting radio signals. The radio signal transceiver module 200 includes an antenna and a duplexer or includes two antennas. The first receiving/transmitting switch 202 is coupled between the radio signal transceiver module 200, the first filtering unit 214, and the first reception module 206, and is disposed for controlling the radio signal transceiver module 200 coupling to the first filtering unit 214 or the first reception module 206. The second receiving/transmitting switch 204 is coupled between the radio signal transceiver module 200, the second filtering unit 216, and the second reception module 210, and is disposed for controlling the radio signal transceiver module 200 coupling to the second filtering unit 216 or the second reception module 210. The first reception module 206 and the first transmitting module 208 are disposed for receiving radio signals and transmitting radio signals respectively to the first communications system. The second reception module 210 and the second transmitting module 212 are disposed for receiving radio signals and transmitting radio signals respectively to the second communications system. The first filtering unit 214 filters out the signals of the overlapping frequency band between the first transmitting module 208 and the second reception module 210. The second filtering unit 216 filters out the signals of the overlapping frequency band between the second transmitting module 212 and the first reception module 206. The first signal processing module 218 is disposed for processing signals of the first transmitting module 208 and the signals of the first reception module 206. The second signal processing module 220 is disposed for processing the signals of the second transmitting module 212 and the signals of the second reception module 210.

Therefore, when the communication device 20 simultaneously operates in the first and the second communications systems, the first filtering unit 214 and the second filtering unit 216 respectively filter out the signals of the first transmitting module 208 and the second transmitting module 212 for avoiding the signals of the first transmitting module 208 interfering with the second reception module 210 and the signals of the second transmitting module 212 interfering with the first reception module 206. The first filtering unit 214 and the second filtering unit 216 are preferred to be low-pass filters or band-pass filters and coupled to the input end of a power amplifier or the output end of the power amplifier.

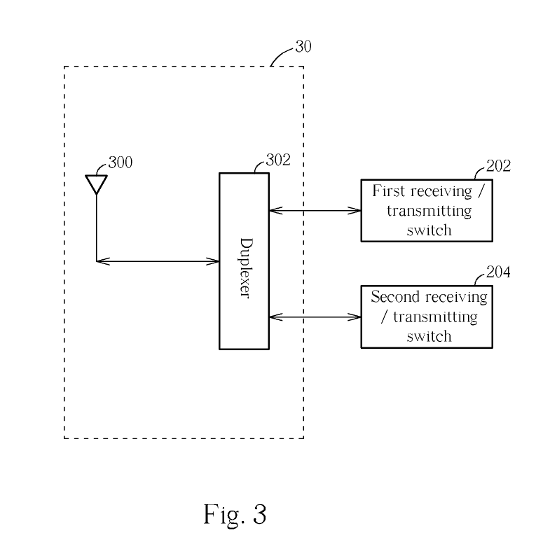

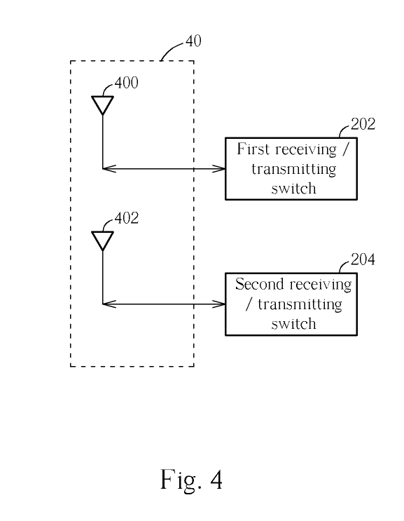

Please refer to FIG. 3 and FIG. 4. FIG. 3 is a diagram illustrating a radio signal transceiver module 30. FIG. 4 is a diagram illustrating a radio signal transceiver module 40. The radio signal transceiver modules 30 and 40 are embodiments of the radio signal transceiver module 200. In FIG. 3, the radio signal transceiver module 30 comprises an antenna 300 and a duplexer 302. The duplexer 302 couples the antenna 300 to the first receiving/transmitting switch 202 or the second receiving/transmitting switch 204. Under such condition, the antenna 300 has to be designed both for the first and the second communications systems so that the design complexity of the antenna 300 is higher and the isolation between the communications systems is deteriorated. In FIG. 4, the radio signal transceiver module 40 comprises antennas 400 and 402. The antennas 400 and 402 are respectively designed for the first communications system and the second communications system, which isolates the first and the second communications systems properly and lowers the design complexity.

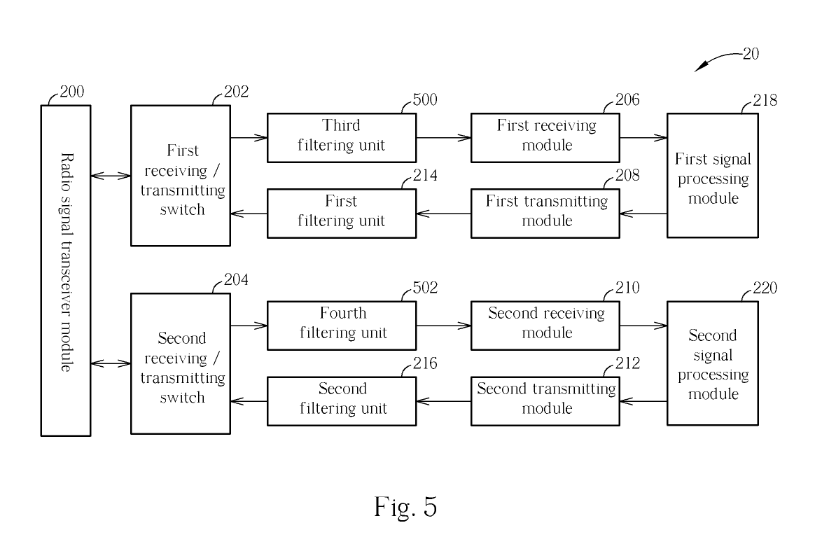

Additionally, the present invention provides filtering units in the reception paths for avoiding the signal saturation of front-end components because of the lack of the isolation, which disables the communications systems from working. Please refer to FIG. 5. FIG. 5 is a diagram illustrating the reception path of the communication device 20 provided with the third filtering unit 500 and the fourth filtering unit 502. The third filtering unit 500 and the fourth filtering unit 502 are preferred to be band-pass filters. Besides, for saving space, it is also allowable to design the filtering units for only one communications system. For example, in FIG. 5, it is allowable to remove the second filtering unit 216 and the fourth filtering unit 502 and to keep the first filtering unit 214 and the third filtering unit 500, or to remove the first filtering unit 214 and the third filtering unit 500 and to keep the second filtering unit 216 and the fourth filtering unit 502.

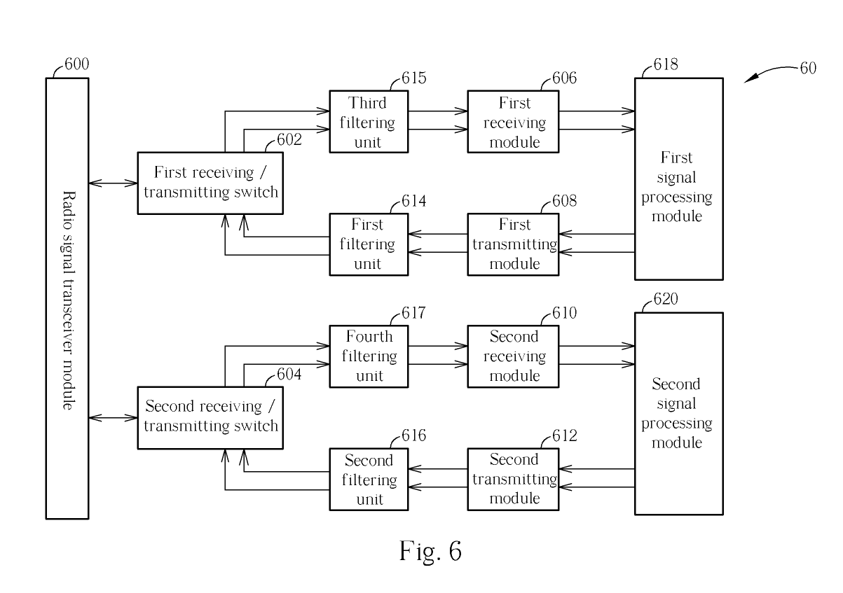

Furthermore, the present invention appropriately arranges the communication device for saving circuit space since the difference between the dual-band communications systems is only frequency. Please refer to FIG. 6. FIG. 6 is a diagram illustrating a communication device 60 of a second embodiment of the present invention. The communication device operates simultaneously in a first dual-band communications system and a second dual-band communications system. The communication device 60 comprises a radio signal transceiver module 600, a first receiving/transmitting switch 602, a second receiving/transmitting switch 604, a first reception module 606, a first transmitting module 608, a second reception module 611, a second transmitting module 612, a first filtering unit 614, a second filtering unit 616, a third filtering unit 611, a fourth filtering unit 611, a first signal processing module 611, and a second signal processing module 620.

The radio signal transceiver module 600 is disposed for receiving and transmitting radio signals. The radio signal transceiver module 600 includes an antenna and a duplexer (as shown in FIG. 3) or two antennas (as shown in FIG. 4). The first receiving/transmitting switch 602 is coupled between the radio signal transceiver module 600, the first filtering unit 611, and the third filtering unit 611 for controlling the radio signal transceiver module 600 coupling to the first filtering unit 611 or the third filtering unit 611. The second receiving/transmitting switch 604 is coupled between the radio signal transceiver module 600, the second filtering unit 611, and the fourth filtering unit 611 for controlling the radio signal transceiver module 600 coupling to the second filtering unit 611 or the fourth filtering unit 611. The first reception module 606 and the first transmitting module 608 are respectively disposed for receiving and transmitting radio signals to the first dual-band communications system. The second reception module 610 and the second transmitting module 611 are disposed respectively for receiving and transmitting radio signals to the second dual-band communications system. The first filtering unit 614 filters out signals of the overlapping frequency band between the first transmitting module 608 and the second reception module 611. The second filtering unit 611 filters out signals of the overlapping frequency band between the second transmitting module 611 and the first reception module 606. The third filtering unit 611 and the fourth filtering unit 611 are disposed for increasing the isolation and avoiding the signal saturation of front-end components. The first signal processing module 611 is disposed for processing signals of the first transmitting module 608 and the first reception module 606. The second signal processing module 620 is disposed for processing signals of the second transmitting module 611 and the second reception module 611.

Therefore, with the first filtering unit 614, the second filtering unit 611, the third filtering unit 611, and the fourth filtering unit 611, the communication device 60 avoids the first transmitting module 608 interfering with the second reception module 610 or the second transmitting module 611 interfering with the first reception module 606. Consequently, the communication device 60 is enabled to operate simultaneously in the first and the second dual-band communications systems.

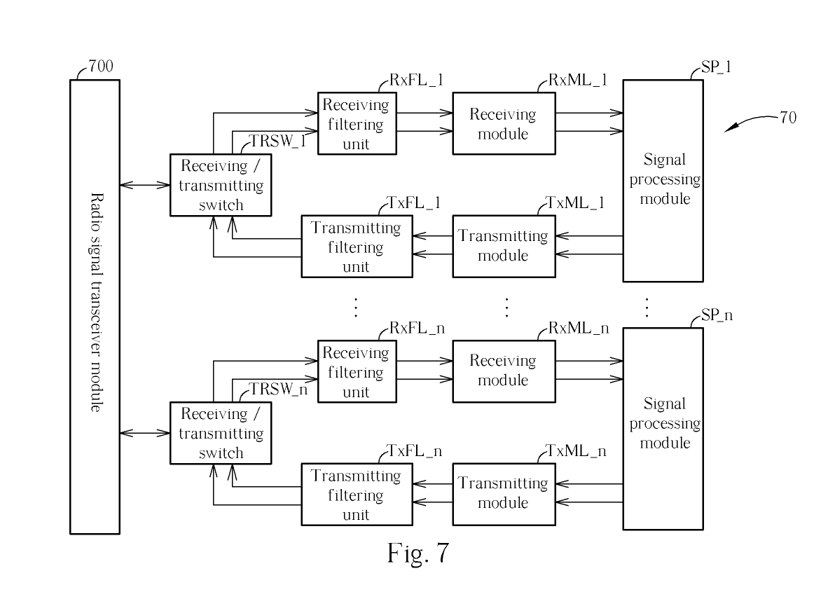

Please refer to FIG. 7. FIG. 7 is a communication device 70 of a third embodiment of the present invention. The communication device 70 operates simultaneously in a plurality of communications systems. The communication device 70 comprises a radio signal transceiver module 700, receiving/transmitting switches TRSW_1 to TRSW_n, reception modules RxML_1 to RxML_n, transmitting modules TxML_1 to TxML_n, transmitting filtering units TxFL_1 to TxFL_n, receiving filtering units RxFL_1 to RxFL_n, signal processing modules SP_1 to SP_n. It is understood that the communication device 60 in FIG. 6 is an instance of the communication device 70 when an amount of the communications systems is 2. Thus, the related description about the communication device 70 is the same as the communication device 60 and is omitted. The transmitting filtering units TxFL_1 to TxFL_n are respectively disposed for filtering out the signals of the corresponding frequency band of the transmitting modules TxML_1 to TxML_n so as to avoid interferences of the reception modules RxML_1 to RxML_n. Similarly, the receiving filtering units RxFL_1 to RxFL_n are respectively disposed for filtering out the signals of the corresponding frequency band of the reception modules RxML_1 to RxML_n so as to avoid interferences of the transmitting modules TxML_1 to TxML_n and increase the degree of the isolation. The transmitting filtering units TxFL_1 to TxFL_n are preferred to be low-pass filters or band-pass filters. The receiving filtering units RxML_1 to RxML_n are preferred to be band-pass filters.

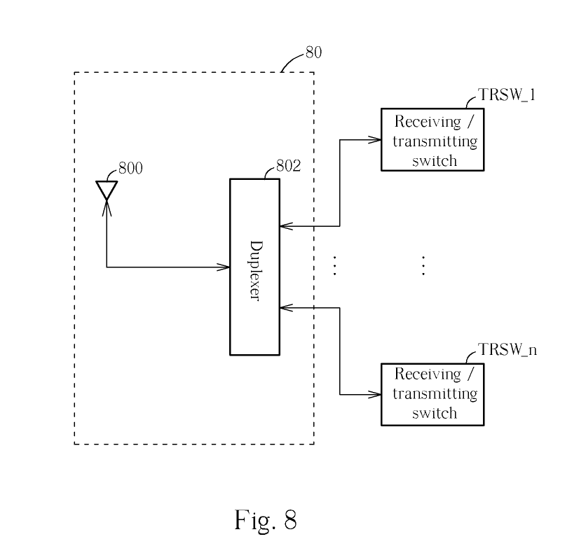

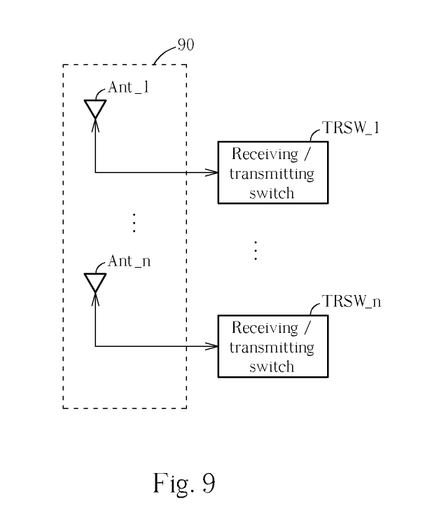

Please refer to FIG. 8 and FIG. 9. FIG. 8 is a diagram illustrating a radio signal transceiver module 80. FIG. 9 is a diagram illustrating a radio signal transceiver module 90. The radio signal transceiver module 700 is realized with the radio signal transceiver module 80 or the radio signal transceiver module 90. In FIG. 8, the radio signal transceiver module 80 comprises an antenna 800 and a duplexer 802. The duplexer 802 controls the antenna 800 to couple to the appropriate receiving/transmitting switch according to the operation of the communication device 70. However, the antenna 800 has to be designed to be applicable to all of the communications systems, which increases the complexity of the design and the isolations between the communications systems are affected. In FIG. 9, the radio signal transceiver module 90 comprises antennas Ant_1 to Ant_n respectively designed for each communications system so as to increase the degree of the isolations and lower the complexity of the design.

Therefore, with the transmitting filtering units TxFL_1 to TxFL_n, the receiving filtering units RxML_1 to RxML_n, the communication device 70 avoids any of the transmitting modules interfering with the receiving filtering units RxML_1 to RxML_n and avoids signal saturation of front-end components. Consequently, the communication device 70 is enabled to operate simultaneously in a plurality of multiple-band communications systems.

To sum up, the present invention avoids the output signals from the transmitting modules interfering with the reception modules by providing filtering units on the transmitting paths and avoids signal saturation of front-end components by providing filtering units on the receiving paths. Therefore, the communication device of the present invention operates simultaneously in a plurality of multi-band communications systems.

Those skilled in the art will readily observe that numerous modifications and alterations of the device and method may be made while retaining the teachings of the invention.

What is claimed is:

1. A communication device capable of operating in a first communications system and a second communications system, the communication device comprising:
a radio signal transceiver module for receiving and transmitting radio signals;
a first reception module for receiving radio signals from the first communications system through the radio signal transceiver module;
a first transmitting module for transmitting radio signals to the first communications system through the radio signal transceiver module;
a second reception module for receiving radio signals from the second communications system through the radio signal transceiver module;
a second transmitting module for transmitting radio signals to the second communications system through the radio signal transceiver module;
a first filtering unit coupled to the first transmitting module for filtering out signals of an overlapping frequency band between a frequency band of output signals of the first transmitting module and a frequency band of received signals of the second reception module; and
a second filtering unit coupled to the second transmitting module for filtering out signals of an overlapping frequency band between a frequency band of output signals of the second transmitting module and a frequency band of received signals of the first reception module.

2. The communication device of claim 1 wherein the radio signal transceiver module comprises a first antenna coupled to the first transmitting module and the first reception module and a second antenna coupled to the second transmitting module and the second reception module.

3. The communication device of claim 1 wherein the radio signal transceiver module comprises an antenna and a duplexer coupled to the first transmitting module, the first reception module, the second transmitting module, and the second reception module.

4. The communication device of claim 1 further comprising:
a first receiving/transmitting switch coupled between the radio signal transceiver module, the first filtering unit, and the first reception module for controlling the radio signal transceiver module to couple to the first filtering unit or the first reception module; and
a second receiving/transmitting switch coupled between the radio signal transceiver module, the second filtering unit, and the second reception module for controlling the radio signal transceiver module to couple to the second filtering unit or the second reception module.

5. The communication device of claim 1 wherein the first filtering unit is a low-pass filter.

6. The communication device of claim 1 wherein the first filtering unit is a band-pass filter.

7. The communication device of claim 1 wherein the second filtering unit is a low-pass filter.

8. The communication device of claim 1 wherein the second filtering unit is a band-pass filter.

9. The communication device of claim 1 further comprising:
a first signal processing module coupled to the first transmitting module and the first reception module for processing signals of the first communications system; and
a second signal processing module coupled to the second transmitting module and the second reception module for processing signals of the second communications system.

10. The communication device of claim 1 further comprising:
a third filtering unit coupled to the first reception module for filtering received signals of the first reception module; and
a fourth filtering unit coupled to the second reception module for filtering received signals of the second reception module.

11. A communication device capable of operating in a first communications system and a second communications system, the communication device comprising:
a radio signal transceiver module for receiving and transmitting radio signals;
a first reception module for receiving radio signals through the radio signal transceiver module from the first communications system;
a first transmitting module for transmitting radio signals through the radio signal transceiver module to the first communications system;
a second reception module for receiving radio signals through the radio signal transceiver module from the second communications system;
a second transmitting module for transmitting radio signals through the radio signal transceiver module to the second communications system;
a first filtering unit coupled to the first transmitting module for filtering out signals of an overlapping frequency band between a frequency band of output signals of the first transmitting module and a frequency band of received signals of the second reception module; and
a third filtering unit coupled to the first reception module for filtering signals received by the first reception module so as to increase a degree of an isolation and avoid signal saturation of front-end components.

12. The communication device of claim 11, wherein the radio signal transceiver module comprises:
a first antenna coupled to the first transmitting module and the first reception module; and
a second antenna coupled to the second transmitting module and the second reception module.

13. The communication device of claim 11, wherein the radio signal transceiver module comprises:
an antenna; and
a duplexer coupled to the first transmitting module, the first reception module, the second transmitting module, and the second reception module.

14. The communication device of claim 11 further comprising:
a first receiving/transmitting switch coupled between the radio signal transceiver module, the first filtering unit, and the third filtering unit for coupling the radio signal transceiver module to the first filtering unit or the third filtering unit; and
a second receiving/transmitting switch coupled between the radio signal transceiver module, the second transmitting module, and the second reception module for coupling the radio signal transceiver module to the second transmitting module or the second receiving module.

15. The communication device of claim 11, wherein the first filtering unit is a low-pass filter.

16. The communication device of claim 11, wherein the first filtering unit is a band-pass filter.

17. The communication device of claim 11, wherein the third filtering unit is a band-pass filter.

18. The communication device of claim 11 further comprising:
a first signal processing module coupled to the first transmitting module and the first reception module for processing signals of the first communications system; and
a second signal processing module coupled to the second transmitting module and the second reception module for processing signals of the second communications system.

19. The communication device of claim 11 further comprising:
a second filtering unit coupled to the second transmitting module for filtering out signals of an overlapping frequency band between a frequency band of output signals of the second transmitting module and a frequency band of received signals of the first receiving module; and
a fourth filtering unit coupled to the second reception module for filtering signals received by the second reception module so as to increase a degree of an isolation and avoid signal saturation of front end components.

20. The communication device of claim 19, wherein the second filtering unit is a low-pass filter.
